(19) United States
(12) Patent Application Publication
(10) Pub. No.: US 2009/0064092 A1
(43) Pub. Date: Mar. 5, 2009

(54) VISUAL PROGRAMMING LANGUAGE OPTIMIZATION

(75) Inventors: Paul C. Roberts, Kirkland, WA (US); Andreas Ulbrich, Kirkland, WA (US)

Correspondence Address: MICROSOFT CORPORATION, ONE MICROSOFT WAY, REDMOND, WA, 98052-6399, US

(73) Assignee: MICROSOFT CORPORATION, Redmond, WA (US)

(21) Appl. No.: 11/847,321

(22) Filed: Aug. 29, 2007

(51) Int. Cl. G06F 9/44

(52) U.S. Cl. 717/105

(57) ABSTRACT

Systems and methods of optimizing a visual programming language dataflow diagram are disclosed herein. A set of work units of the visual programming language dataflow diagram is parsed. A subset of the set of work units that follow a programming pattern is identified. The programming pattern can be a set of criteria satisfied by the subset of work units. A comprehension work unit that maps to the programming pattern can be selected. In one embodiment, the comprehension work unit can be a run-length comprehension work unit, a join comprehension work unit, a choice comprehension work unit, or a merge comprehension work unit. The subset of work units in the visual programming language dataflow diagram is replaced with the comprehension work unit. Imperative computer code can then be generated from the visual programming language dataflow diagram.

### BACKGROUND

Computer applications are commonly developed by application developers using a typical development environment. Such a development environment generally includes a text editor, a compiler, and a debugger. The application developer uses the text editor to enter source code written in a development language such as C, C++, or C#. The compiler translates the computer source code to object code. Object code may be code or instructions directly executable by the computer's central processing unit. The object code may require further standard software modules to be linked in order to create an executable application.

During application development, the program elements are available for a user to manipulate using a GUI. In visual programming, the GUI may be used by a user to draw the logic and dataflow of an application such that the resulting diagram resembles a conventional flowchart. However, in contrast to a conventional flowchart, the diagram does not abstractly represent the application and instead completely describes the functioning of the application. Programs written in a visual programming language are generally translated into a functionally equivalent program in a conventional object-oriented language. The generated code is generally accessed by human programmers in order to edit, debug and test the code.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The methods and systems disclosed herein permit the optimization of a visual programming language dataflow diagram by recognizing programming patterns and collapsing such recognized patterns into comprehension work units. As such, the work units in a visual programming language dataflow diagram can be parsed to identify a subset work units that follow a programming pattern. The programming pattern is identified if a set of criteria is satisfied by the subset of work units. Programming patterns discussed below include a run-length comprehension programming pattern, a join comprehension programming pattern, a merge comprehension programming pattern, and a choice comprehension programming pattern.

The programming pattern can be a run-length comprehension programming pattern. The run-length comprehension programming pattern can be a plurality of work units arranged sequentially, and wherein each work unit in the plurality of work units have one input and one output message. The programming pattern can be a join comprehension programming pattern. In one example, the join comprehension programming pattern can be the programming pattern that comprises at least two work units that receive a common input and that produce a join output. In another example, the join comprehension programming pattern can be a first sequence of work units, and a second sequence of work units, wherein the first sequence of work units and the second sequence of work units receive a common input and that produce a join output. The programming pattern can be a merge comprehension programming pattern. The merge comprehension programming pattern can comprise a selection work unit that includes a set of predicate expressions, each predicate expression in the set of predicate expressions being associated with a sequentially-arranged set of work units. The programming pattern can be a choice comprehension programming pattern. The choice comprehension programming pattern can comprise a selection work unit that includes a set of predicate expressions, each predicate expression in the set of predicate expressions being associated with a sequentially-arranged set of work units which produce output to a common receiving work unit.

Once the programming pattern is identified, the subset of work unit associated with the programming pattern is replaced with the appropriate comprehension work unit. Depending upon the programming pattern identified, the comprehension work unit can be a run-length comprehension work unit, a join comprehension work unit, a merge comprehension work unit, or a choice comprehension work unit. Each comprehension work unit can be used to generate imperative computer code that includes collecting the computer code associated with each work unit in the subset of work units.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates a component diagram of a system for comprehending and generating code from a visual programming language according to one embodiment.

FIG. 2 illustrates a subset of visual programming language work units that can be replaced by a run-length comprehension work unit according to one embodiment.

FIG. 3 illustrates a subset of visual programming language work units that can be replaced by a join comprehension work unit according to one embodiment.

FIG. 4 illustrates a subset of visual programming language work units that can be replaced by a merge comprehension work unit according to one embodiment.

FIG. 5 illustrates a subset of visual programming language work units that can be replaced by a choice comprehension work unit according to one embodiment.

FIG. 6 illustrates a flow diagram of a process for optimizing a visual programming language diagram according to one embodiment.

FIG. 7 illustrates a flow diagram of a process for optimizing a visual programming language diagram according to another embodiment.

FIG. 8 illustrates a flow diagram of a process for optimizing a visual programming language diagram according to yet another embodiment.

FIG. 9 illustrates a component diagram of a computing device for implementing one or more embodiments.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a distributed debugging system for a visual programming language, the system described is provided as an example and not a limitation. As those skilled in the art will appreciate, the present examples are suitable for application in a variety of different types of distributed debugging system for a visual programming language.

The systems and methods disclosed herein permit the creation of a visual programming language dataflow diagram, optimization of such diagram, and code generation. In contrast to a flowchart, visual programming language dataflow diagram is not a schematic for how the program should be structured, but rather it is a complete description of the program. Blocks in the dataflow diagram represent work items. Lines connecting the blocks connect from the data sources of work items to the data sinks of work items. Unlike in a conventional, sequential programming language, a dataflow program is not a step-by-step execution plan. A work item performs an action on upon receiving an input message and produces one or more output messages. The program is thus driven by the receiving and transmission of data. A dataflow programming language provides a small set of primitive work items from which other work items can be constructed. Therefore, a work unit refers to an atomic unit of visual programming language that is directly translated into imperative language based on known characteristics of the work unit. Conventional methods execute dataflow programs by mapping every work unit in the program to the corresponding imperative code in the computer program at runtime. Code generated from such systems yields non-cohesive computer code that is dissimilar to human written programs with the same function and therefore difficult to understand and modify. Furthermore, the overhead of sending and receiving messages for every work unit leads to poor runtime performance. By optimizing the dataflow diagram of a program, the resulting program can be more efficient, and more readable to a human reader.

The work units that follow a predetermined programming pattern can be used to generate cohesive, coalesced source code from the source code corresponding to each of the individual work units. To do this, such work units can be replaced, in the visual programming language dataflow diagram, with a comprehension work unit. As used herein, the term comprehension refers to recognition of a part of the dataflow diagram (e.g., a set of work units) that follows a programming pattern and replacing with a comprehension work unit. Therefore, as explained below, comprehension work units are used to replace predetermined programming patterns. Once all the programming patterns are recognized and replaced by corresponding comprehension work units, imperative code can be generated. Such generated code can be more easily understood by a human programmer because the associated computer code can be more cohesive and generated to be in the same listing of instructions. In addition, the posting of messages between individual work units can be avoided, thus improving the runtime performance.

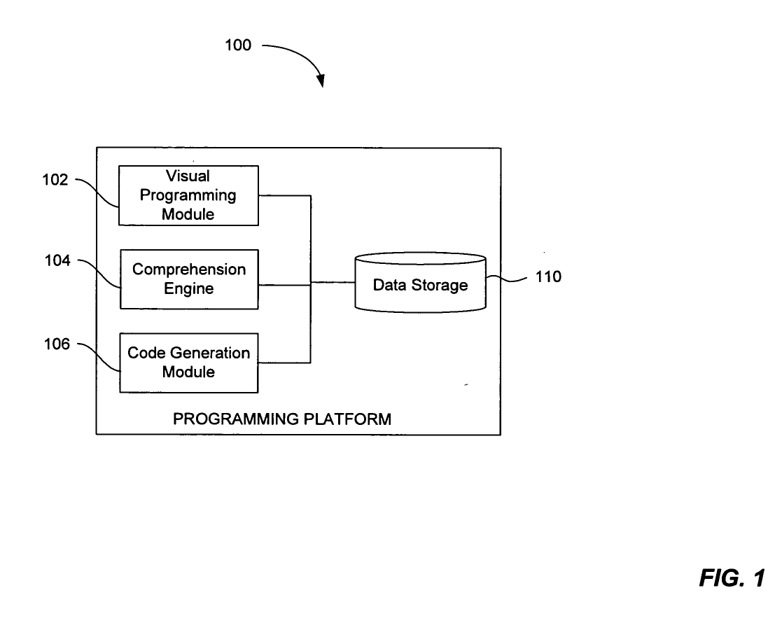

FIG. 1 illustrates a component diagram of a system for optimizing a visual programming language according to one embodiment. The programming platform 100 can be a standalone application that permits a user, such as a computer programmer, to visually create a computer program. The programming platform can be configured to permit a user to add, edit, delete and manipulate work units and the relationships among work units. In one embodiment, the visual programming platform 100 can include a visual programming module 102, and a comprehension engine 104. Furthermore, the visual programming platform 100 can also include a code generation module 106.

The visual programming module 102 can be configured to receive visual programming input and to manage work units in a visual programming language dataflow diagram. As such, the visual programming module 102 can receive input from a user to add a new work unit, such as a data work unit, variable work unit, output work unit, etc. In addition, the visual programming module 102 can also be configured to permit a user to select the input for a work unit, the action taken by the work unit, and the destination of the output of a work unit.

In one embodiment, the comprehension engine 104 can be configured to parse a set of work units of the visual programming language dataflow diagram. The comprehension engine 104 can be further configured to identify a subset of a set of work units that follow a programming pattern. The programming pattern can be a set of criteria satisfied by the subset of work units. The programming pattern can be, for example, a subset of work units that are sequentially arranged such that the output of one work unit serves as the input for another work unit. As such, the work units in such arrangement would receive a common input and that produce a single output.

In another example, the programming pattern can comprise a selection work unit that includes a set of predicate expressions, each predicate expression in the set of predicate expressions being associated with a sequentially-arranged set of work units. In yet another example, the programming pattern can comprise a selection work unit that includes a set of predicate expressions, each predicate expression in the set of predicate expressions being associated with a sequentially-arranged set of work units which produce output to a common receiving work unit.

Once the comprehension engine 104 identifies a programming pattern in the visual programming language dataflow diagram, the comprehension engine 104 can be further configured to select a comprehension work unit that maps to the programming pattern. The comprehension engine 104 can then replace the subset of work units in the visual programming language dataflow diagram with the identified comprehension work unit.

In one aspect, the data storage 110 can be implemented to store visual programming language dataflow diagrams including work units and work units relationships. Therefore, data storage 110 can be accessible to the visual programming module 102, the comprehension engine 104, and the code generation module 106 in order retrieve or store visual programming language dataflow diagrams.

In a further aspect, the data storage 110 can be configured to store programming patterns for evaluating work units. Therefore, the criteria that has to be met for a specific programming pattern can be stored in the data storage 110. In yet another aspect, the data storage 110 can be configured to store comprehension work units that map to programming patterns. Examples of programming patterns as disclosed herein, include a run-length comprehension programming pattern, a join comprehension programming pattern, a merge comprehension programming pattern, and a choice comprehension programming pattern.

In a further embodiment, the code generation module 106 can be configured to generate code once the visual programming language dataflow diagram has been optimized by the comprehension engine 104. As such, the code generation module 106 can be configured with logic to generate imperative code from each of the work units and their relationship as provided in the visual programming language dataflow diagram.

One skilled in the art will recognize that the data repository 110 can be combined into one or more databases, and be located either locally or remotely. In addition, the data repository 110 can be any type of data repository configured to store data and can be implemented using any methods of storage now known or to become known. Likewise, while various modules have described herein, one skilled in the art will recognize that each of the aforementioned modules can be combined into one or more modules, and be located either locally or remotely. Each of these modules can exist as a component of a computer program or process, or be standalone computer programs or processes recorded in a data repository.

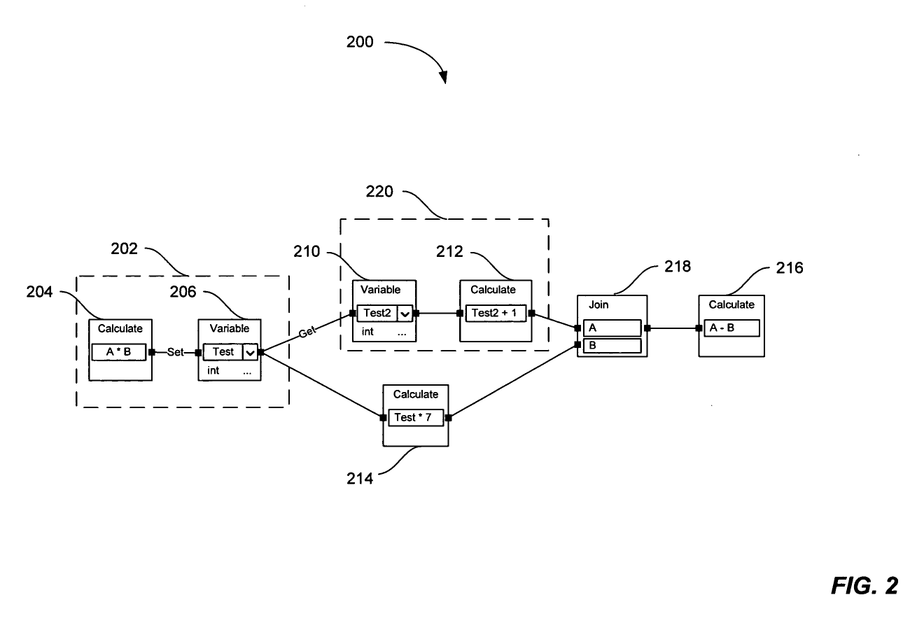

FIG. 2 illustrates a subset of visual programming language work units that can be replaced by a run-length comprehension work unit according to one embodiment. Dataflow diagram 200 is an exemplary diagram that includes work units 204-216. The dataflow diagram 200 shows a partial visual programming language dataflow diagram where two run-length comprehension programming patterns are illustrated. In one embodiment, a run-length comprehension programming pattern comprises a sequence of work units that have exactly one input and one output message each.

As previously mentioned, the comprehension engine 104 can be configured to identify a subset of work units that follow a run-length comprehension programming pattern and replace a run-length comprehension work unit for the subset of work units. Thus, in the dataflow diagram 200, work units 204 and 206 follow a run-length comprehension programming pattern since work units 204 and 206 are a sequence of work units having one input and one output. The run-length comprehension programming pattern can also include an exception that the first work unit in the sequence of work units is not required to have an input. Thus, work unit 204 would not have to have an input to be part of the sequence of work units that follow the run-length comprehension programming pattern. In another example, in the dataflow diagram 200, work units 210 and 212 are a sequence of work units having one input and one output.

Therefore, once these run-length comprehension programming patterns are identified, the comprehension engine 104 can replace work units 204 and 206 with the run-length comprehension work unit 202. In addition, the comprehension engine 104 can replace work units 210 and 212 with the run-length comprehension work unit 220. This replacement permits the dataflow diagram 200 to be better optimized before code generation is carried out. Once such optimization is finalized, source code is generated from the dataflow diagram 200. If additional programming patterns are identified, the dataflow diagram 200 can continue to be optimized. For each type of work unit a source code template is applied. Table A is an exemplary table showing the generated code for the dataflow diagram 200.

TABLE A

State.Test = message.A * message.B;
StateType a = new StateType( );
a.Test = State.Test;
int b = State.Test2 + 1;
JoinAlphaPorts[0].Post(b)
int c = a.Test * 7
JoinAlphaPorts[1].Post(c)
// A subsequent method receiving the data sent to JoinAlpha
JoinAlpha message = new JoinAlpha(args);
int a = message.A − message.B;

As shown in Table A, for a run-length comprehension, a sequence of statements is created based on the run-length comprehension work unit.

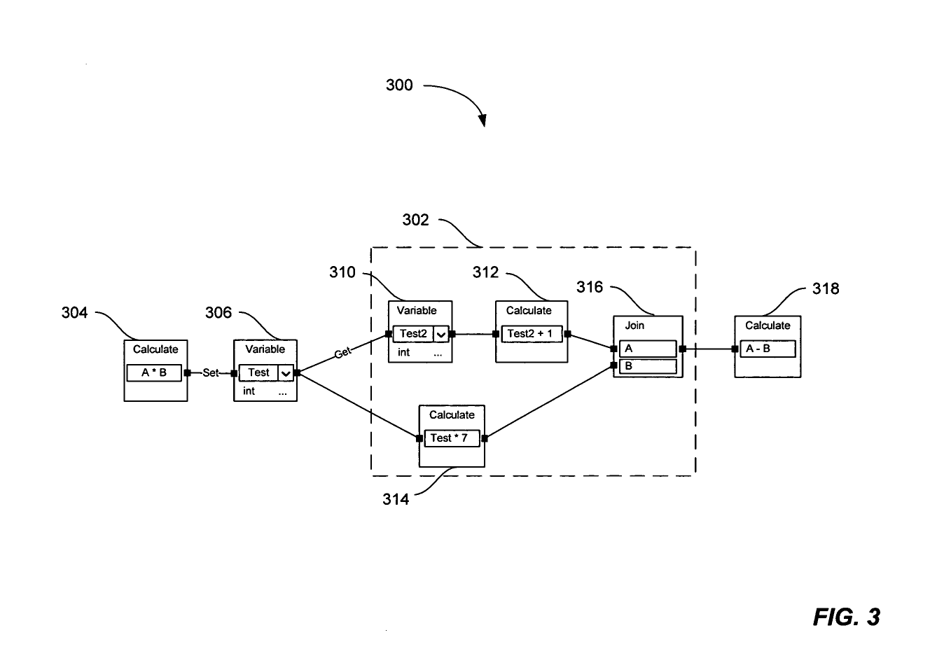

FIG. 3 illustrates a subset of visual programming language work units that can be replaced by a join comprehension work unit according to one embodiment. Dataflow diagram 300 is an exemplary diagram that includes work units 304-318. The dataflow diagram 300 shows a partial visual programming language dataflow diagram where a join comprehension programming pattern is illustrated. In one embodiment, a join comprehension programming pattern comprises at least two work units that receive a common input and that produce a join output. In another embodiment, a join comprehension programming pattern comprises a first sequence of work units, and a second sequence of work units. The first sequence of work units and the second sequence of work units receive a common input and that produce a join output.

In one embodiment, the comprehension engine 104 can be configured to identify a subset of work units that follow a join comprehension programming pattern and replace a join comprehension work unit for such a subset of work units. Thus, in the dataflow diagram 300, work units 310-316 follow a join comprehension programming pattern since work units 310 and 312 correspond a sequence of work units that has a common input and produce a join output with work unit 314. The join comprehension programming pattern can also include asynchronous data paths. For example, in the dataflow diagram 300, work units 310 and 312 establish one data path, and work unit 314 establishes another data path. These data paths are asynchronous and independent of one another. Work unit 316 can also be part of the join comprehension programming pattern.

Once the join comprehension programming pattern is identified, the comprehension engine 104 can replace work units 310, 312, 314, and 316 with the join comprehension work unit 302. This replacement permits the dataflow diagram 300 to be better optimized before code generation is carried out. For each type of work unit a source code template is applied. Table B is an exemplary table showing the generated code for the dataflow diagram 300.

TABLE B

State.Test = message.A * message.B;
StateType a = new StateType( );
a.Test = State.Test;
JoinAlpha alpha = new JoinAlpha( );
alpha.A = State.Test2 + 1;
alpha.B = a.Test * 7;
int b = alpha.A − alpha.B;

As shown in Table B, for a join comprehension programming pattern, a sequence of statements for creating an output message based on stored values is created. For instance, the value of the variable Test2 as shown by work unit 312, and the value of the variable Test after the calculation performed at work unit 314 can be both used as parameters to create a message that includes both values A and B at the work unit 316.

In one embodiment, a set of work units can be maximally optimized if they can be reduced to a single work unit according to identified programming patterns. As such, the comprehension engine 104 can replace work units 304, 306, 318, and the new replacement join comprehension work unit 302 with a run-length comprehension work unit (not shown). Multiple iterations of optimization can be carried out. In this example, after two iterations, all the work units can be reduced to a single work unit that can be used to generate more cohesive and human-comprehensible computer code. The final generated code can include a list of computer instructions containing the instructions from work units 304, 306, join comprehension work unit 302, and work unit 318.

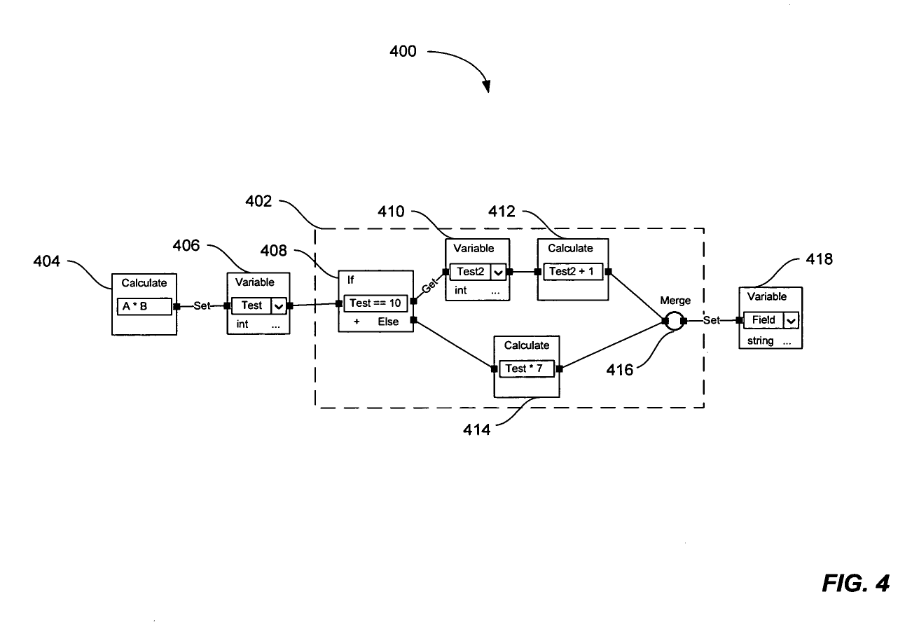

FIG. 4 illustrates a subset of visual programming language work units that can be replaced by a merge comprehension work unit according to one embodiment. Dataflow diagram 400 is an exemplary diagram that includes work units 404-418. The dataflow diagram 400 shows a partial visual programming language dataflow diagram where a merge comprehension programming pattern is illustrated. In one embodiment, a merge comprehension programming pattern comprises a selection work unit that includes a set of predicate expressions, each predicate expression in the set of predicate expressions being associated with a sequentially-arranged set of work units which produce output to a common receiving work unit. As such, the common receiving work unit can receive multiple outputs from more than one data flow, and route such data to other work units.

In one embodiment, the comprehension engine 104 can be configured to identify a subset of work units that follow a merge comprehension programming pattern and replace a merge comprehension work unit for such a subset of work units. Thus, in the dataflow diagram 400, work unit 408 is a selection work unit that includes one or more predicate expressions. Moreover, work unit 416 is a common receiving work unit that receives outputs from work units 412 and 414. As such, work units 408-416 follow a merge comprehension programming pattern since work units 410 and 412 correspond to a sequentially-arranged set of work units, and work unit 414 is also a sequentially arranged set of work units. As such, both sequentially-arranged set of work units each provide a data path that originate from selection work unit 408 and produce a merge output at work unit 416. The merge comprehension programming pattern can also include asynchronous data paths. For example, in the dataflow diagram 400, work units 410 and 412 establish one data path, and work unit establishes another data path. These data paths are asynchronous and independent of one another.

Further, once the merge comprehension programming pattern is identified, the comprehension engine 104 can replace work units 408, 410, 412, 414, and 416 with the merge comprehension work unit 402. As previously mentioned, replacements using comprehension work units permit optimization of the dataflow diagram 400 before code generation is carried out. For each type of work unit a source code template is applied. Table C is an exemplary table showing the generated code for the dataflow diagram 400.

TABLE C

```
State.Test = message.A * message.B;
StateType a = new StateType( );
a.Test = State.Test;
int b;
if (a.Test == 10)
{
  b = State.Test2 + 1;
}
else
{
  b = a.Test * 7;
}
State.Field = b;
```

As shown in the Table C, for a merge comprehension programming pattern an if-then-else statement containing the predicate expressions of the work unit 408 can be generated. The if-then-else statement can be followed by one or more statements corresponding to the work unit 418.

Any input message received by the merge work unit 416 is passed as an output to work unit 418. Thus, variable Field can be set using either the output of the calculation of work unit 414, or the output of the calculation of work unit 412.

As mentioned above, a set of work units can be maximally optimized if they can be reduced to a single work unit according to identified programming patterns. As such, the comprehension engine 104 can replace work units 404, 406, 418, and the new replacement merge comprehension work unit 402 with a run-length comprehension work unit (not shown). Multiple iterations of optimization can be carried out. In this example, after two iterations, all the work units can be reduced to a single work unit that can be used to generate computer code. The final generated code can include a list of computer instructions containing the instructions from work units 404, 406, merge comprehension work unit 402, and work unit 418.

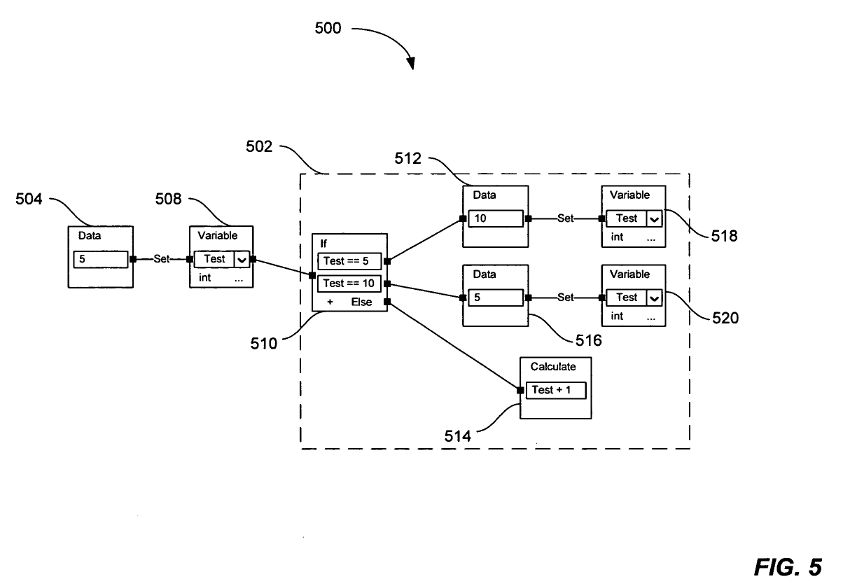

FIG. 5 illustrates a subset of visual programming language work units that can be replaced by a choice comprehension work unit according to one embodiment. Dataflow diagram 500 is an exemplary diagram that includes work units 504-520. The dataflow diagram 500 shows a partial visual programming language dataflow diagram where a choice comprehension programming pattern is illustrated. In one embodiment, a choice comprehension programming pattern comprises a selection work unit that includes a set of predicate expressions, each predicate expression in the set of predicate expressions being associated with a sequentially-arranged set of work units.

In one embodiment, the comprehension engine 104 can be configured to identify a subset of work units that follow a choice comprehension programming pattern and replace a choice comprehension work unit for such a subset of work units. Thus, in the dataflow diagram 500, work unit 510 is a selection work unit that includes one or more predicate expressions. As such, work units 510-520 follow a choice comprehension programming pattern since work units 512 and 518 correspond to a sequentially-arranged set of work units, work units 516 and 520 correspond to another sequentially-arranged set of work units, and work unit 514 is also a sequentially arranged set of work units. As such, each sequentially-arranged set of work units each provide a data path that originate from selection work unit 510 and produce an asynchronous output at the end of each data path, namely work units 518, 520, and 514.

Further, once the choice comprehension programming pattern is identified, the comprehension engine 104 can replace work units 510, 512, 514, 516, 518 and 520 with the choice comprehension work unit 502. As previously mentioned, replacements using comprehension work units permit optimization of the dataflow diagram 500 before code generation is carried out. For each type of work unit a source code template is applied. Table D is an exemplary table showing the generated code for the dataflow diagram 500.

TABLE D

```
State.Test = 5;
StateType a = new StateType( );
a.Test = State.Test;
if (a.Test == 10)
{
  State.Test2 = 10;
}
else if (a.Test == 5)
{
  State.Test2 = 5;
}
else
{
  int b = a.Test + 1;
}
```

As shown in Table D, for a choice comprehension programming pattern, an if-then-else statement containing the predicate expressions of the selection work unit 510 can be generated. For instance, the value of the variable Test2 as shown by work units 518, 520, and 514 can vary depending upon the data path that was selected at the selection work unit 510.

Furthermore, the comprehension engine 104 can replace work units 504, 508, and the new replacement choice comprehension work unit 502 with a run-length comprehension work unit (not shown). Multiple iterations of optimization can be carried out. The final generated code can include a list of computer instructions containing the instructions from work units 504, 308, and choice comprehension work unit 502.

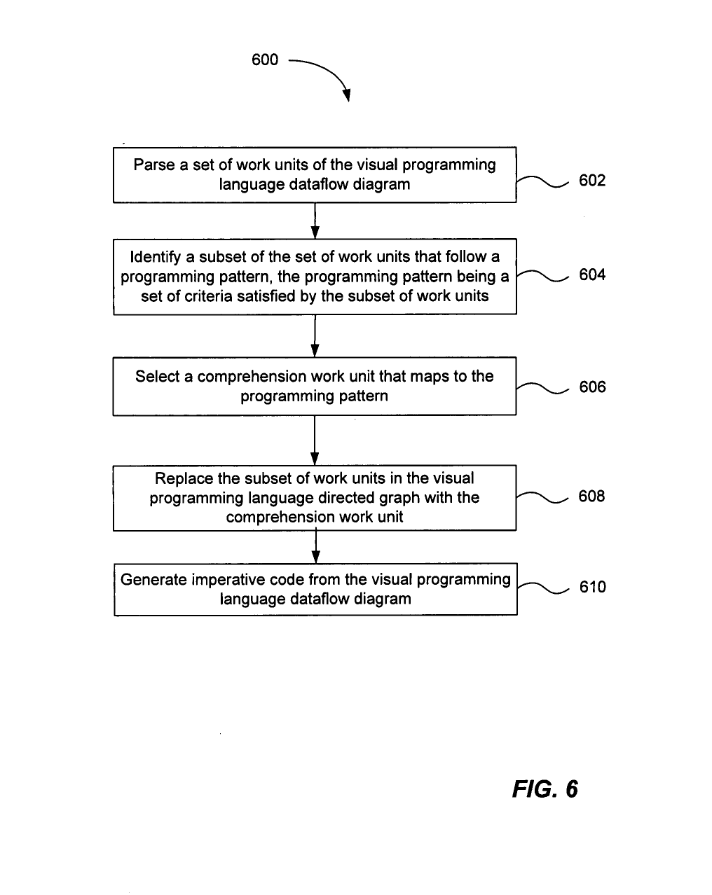

FIG. 6 illustrates a flow diagram of a process for optimizing a visual programming language diagram according to one embodiment. At process block 602, a set of work units of the visual programming language dataflow diagram is parsed. Process 600 continues at process block 604.

At process block 604, a subset of the set of work units that follow a programming pattern is identified. The programming pattern can be a set of criteria satisfied by the subset of work units. Process 600 continues at process block 606.

At process block 606, a comprehension work unit that maps to the programming pattern is selected. The comprehension work unit can be a run-length comprehension work unit, a join comprehension work unit, a merge comprehension work unit, or a choice comprehension work unit. Process 600 continues at process block 608.

At process block 608, the subset of work units in the visual programming language dataflow diagram is replaced with the comprehension work unit. Process 600 continues at process block 610. At process block 610, imperative code can be generated from the visual programming language dataflow diagram.

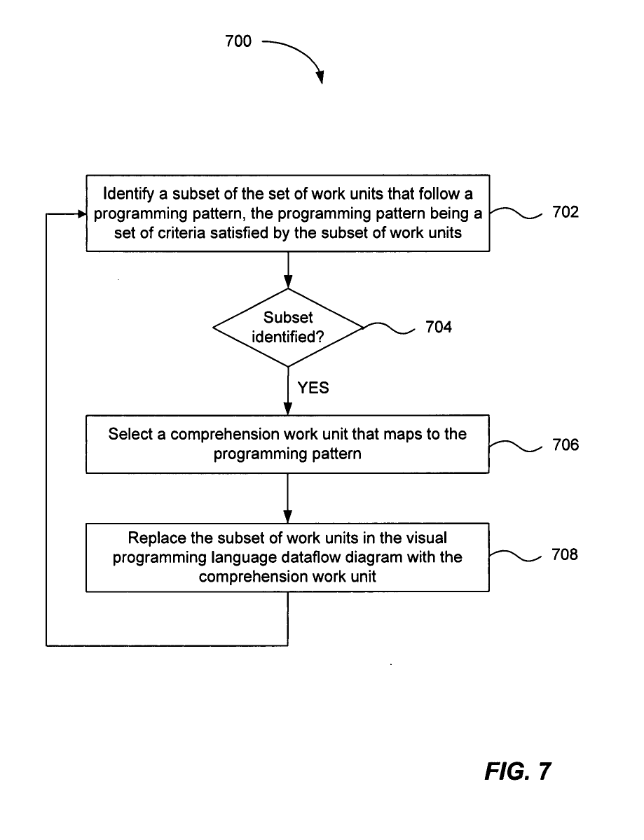

FIG. 7 illustrates a flow diagram of a process for optimizing a visual programming language diagram according to another embodiment. At process block 702, a set of work units of the visual programming language dataflow diagram is parsed. Process 700 continues at decision block 704. At decision block 704, it is determined whether there is an additional subset of work units that follow a programming pattern the subset of work units can be replaced by a comprehension work unit. If there are additional subsets of work units that follow a programming pattern, process 700 continues at process block 706.

At process block 706, a comprehension work unit that maps to the programming pattern is selected. Process 700 continues at process block 708. At process block 708, a subset of work units in the visual programming language dataflow diagram is replaced with the comprehension work unit. Process 700 continues at process block 702 such that process 700 becomes iterative until decision block 704 ends the iteration. The iteration can be terminated if at decision block 704 no additional sets of work units are determined to follow a programming pattern.

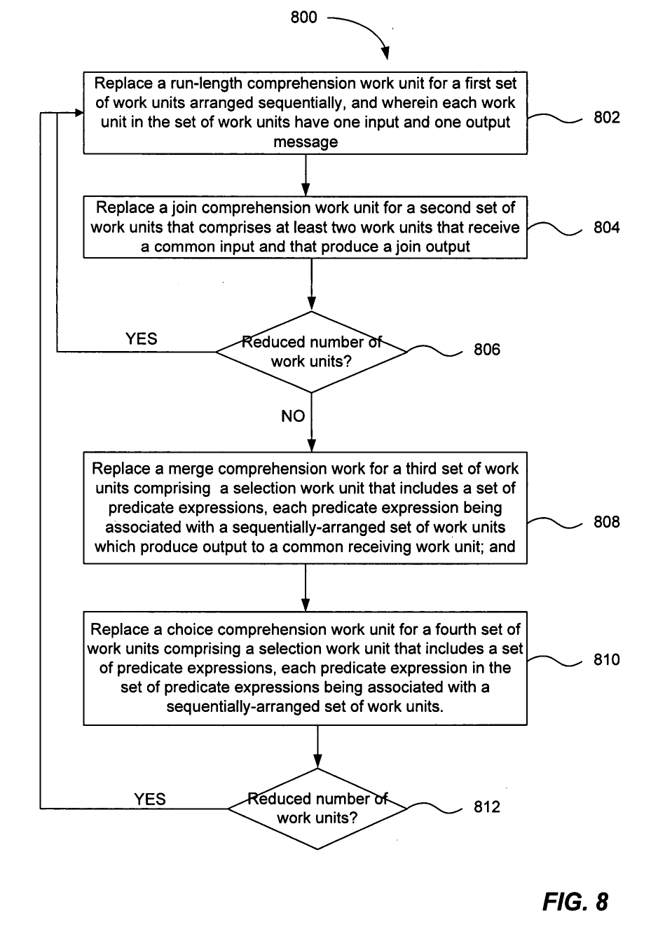

FIG. 8 illustrates a flow diagram of a process for optimizing a visual programming language diagram according to yet another embodiment. As part of process 800, an initial number of work units in a visual programming dataflow diagram can be determined. At process block 802, a first set of work units arranged sequentially is identified. Each work unit in the set of work units can have one input and one output message. The first set of work units in the visual programming language dataflow diagram can then be replaced with a run-length comprehension work unit. Process 800 continues at process block 804.

At process block 804, a second set of work units that comprises at least two work units that receive a common input and that produce a join output is identified. The second set of work units in the visual programming language dataflow diagram can be replaced with a join comprehension work unit. Process 800 continues at decision block 806.

At decision block 806, a second number of work units in the visual program dataflow diagram can be determined. If the second number is less than the initial number of work units, decision block 806 continues at process block 802. Otherwise, decision block 806 continues at process block 808.

At process block 808, a third set of work units comprising a selection work unit that includes a set of predicate expressions is identified. Each predicate expression in the set of predicate expressions can be associated with a sequentially-arranged set of work units which produce output to a common receiving work unit. The third set of work units in the visual programming language dataflow diagram can be replaced with a merge comprehension work unit. Process 800 continues at process block 810.

At process block 810, a fourth set of work units comprising a selection work unit that includes a set of predicate expressions is identified. Each predicate expression in the set of predicate expressions can be associated with a sequentially-arranged set of work units. The fourth set of work units in the visual programming language dataflow diagram can be replaced with a choice comprehension work unit. Process 800 continues at decision block 812.

At decision block 812, a final number of work units in the visual program dataflow diagram can be determined. If the final number is less than the second number of work units, decision block 812 continues at process block 802.

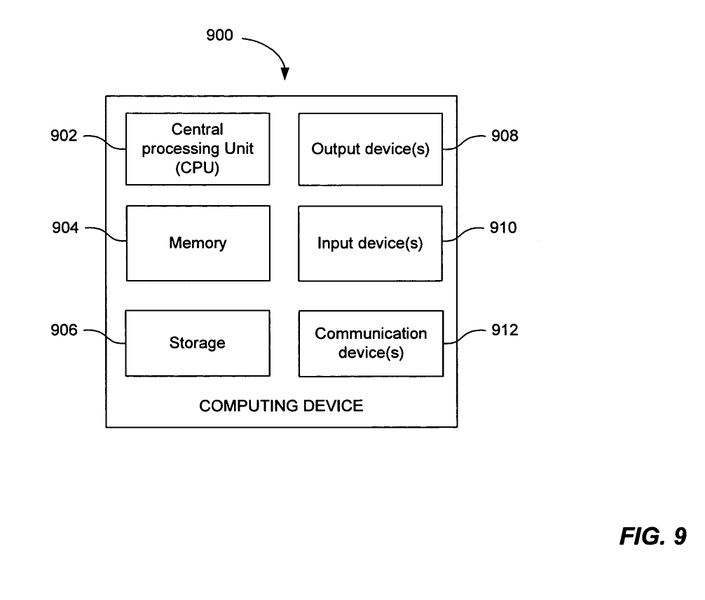

FIG. 9 illustrates a component diagram of a computing device according to one embodiment. The computing device 900 can be utilized to implement one or more computing devices, computer processes, or software modules described herein. In one example, the computing device 900 can be utilized to process calculations, execute instructions, receive and transmit digital signals. In another example, the computing device 900 can be utilized to process calculations, execute instructions, receive and transmit digital signals, receive and transmit search queries, and hypertext, compile computer code, as required by the visual programming module 102, the comprehension engine 104, and the code generation module 106.

The computing device 900 can be any general or special purpose computer now known or to become known capable of performing the steps and/or performing the functions described herein, either in software, hardware, firmware, or a combination thereof.

In its most basic configuration, computing device 900 typically includes at least one central processing unit (CPU) 902 and memory 904. Depending on the exact configuration and type of computing device, memory 904 may be volatile (such as RAM), non-volatile (such as ROM, flash memory, etc.) or some combination of the two. Additionally, computing device 900 may also have additional features/functionality. For example, computing device 900 may include multiple CPU's. The described methods may be executed in any manner by any processing unit in computing device 900. For example, the described process may be executed by both multiple CPU's in parallel.

Computing device 900 may also include additional storage (removable and/or non-removable) including, but not limited to, magnetic or optical disks or tape. Such additional storage is illustrated in FIG. 9 by storage 206. Computer storage media includes volatile and nonvolatile, removable and non-removable media implemented in any method or technology for storage of information such as computer readable instructions, data structures, program modules or other data. Memory 904 and storage 906 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 900. Any such computer storage media may be part of computing device 900.

Computing device 900 may also contain communications device(s) 912 that allow the device to communicate with other devices. Communications device(s) 912 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 900 may also have input device(s) 910 such as keyboard, mouse, pen, voice input device, touch input device, etc. Output device(s) 908 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A method of optimizing a visual programming language dataflow diagram, comprising:
parsing a set of work units of the visual programming language dataflow diagram;
identifying a subset of the set of work units that follow a programming pattern, the programming pattern being a set of criteria satisfied by the subset of work units;
selecting a comprehension work unit that maps to the programming pattern; and
replacing the subset of work units in the visual programming language dataflow diagram with the comprehension work unit.

2. The method of claim 1, further comprising generating imperative computer code from the visual programming language dataflow diagram.

3. The method of claim 2, wherein generating the imperative computer code includes collecting computer code associated with each work unit in the subset of work units.

4. The method of claim 1, wherein the comprehension work unit is a run-length comprehension work unit, a join comprehension work unit, a choice comprehension work unit, or a merge comprehension work unit.

5. The method of claim 1, wherein the programming pattern is a plurality of work units arranged sequentially, and wherein each work unit in the plurality of work units has one input and one output message.

6. The method of claim 1, wherein the programming pattern comprises at least two work units that receive a common input and that produce a join output.

7. The method of claim 1, wherein the programming pattern comprises a first sequence of work units, and a second sequence of work units, wherein the first sequence of work units and the second sequence of work units receive a common input and that produce a join output.

8. The method of claim 1, wherein the programming pattern comprises a selection work unit that includes a set of predicate expressions, each predicate expression in the set of predicate expressions being associated with a sequentially-arranged set of work units.

9. The method of claim 1, wherein the programming pattern comprises a selection work unit that includes a set of predicate expressions, each predicate expression in the set of predicate expressions being associated with a sequentially-arranged set of work units which produce output to a common receiving work unit.

10. A method of generating imperative code from a visual programming language dataflow diagram, comprising:
determining an initial number of work units in a visual programming dataflow diagram;
identifying a first set of work units arranged sequentially, and wherein each work unit in the set of work units have one input and one output message;
replacing the first set of work units in the visual programming language dataflow diagram with a run-length comprehension work unit;
identifying a second set of work units that comprises at least two work units that receive a common input and that produce a join output; and
replacing the second set of work units in the visual programming language dataflow diagram with a join comprehension work unit.

11. The method of claim 1, further comprising determining a second number of work units in the visual program dataflow diagram, and if the second number is less than the initial number of work units repeating the method of claim 1.

12. The method of claim 11, further comprising:
identifying a third set of work units comprising a selection work unit that includes a set of predicate expressions, each predicate expression in the set of predicate expressions being associated with a sequentially-arranged set of work units which produce output to a common receiving work unit; and
replacing the third set of work units in the visual programming language dataflow diagram with a merge comprehension work unit.

13. The method of claim 12, further comprising determining a final number of work units in the visual program dataflow diagram, and if the final number is less than the second number of work units repeating the method of claim 10.

14. The method of claim 11, further comprising:
identifying a fourth set of work units comprising a selection work unit that includes a set of predicate expressions, each predicate expression in the set of predicate expressions being associated with a sequentially-arranged set of work units; and
replacing the fourth set of work units in the visual programming language dataflow diagram with a choice comprehension work unit.

15. The method of claim 14, further comprising determining a final number of work units in the visual program dataflow diagram, and if the final number is less than the second number of work units repeating the method of claim 1.

16. A system of optimizing a visual programming language dataflow diagram, comprising:
a visual programming module for receiving visual programming input and managing work units created as part of the visual programming input; and
a comprehension module configured to parse a set of work units of the visual programming language dataflow diagram, the comprehension module further configured to identify a subset of the set of work units that follow a programming pattern, the programming pattern being a set of criteria satisfied by the subset of work units, the comprehension module further configured to select a comprehension work unit that maps to the programming pattern, the comprehension module further configured to replace the subset of work units in the visual programming language dataflow diagram with the comprehension work unit.

17. The system of claim 16, further comprising a code generation module that generates imperative code from the visual programming language dataflow diagram.

18. The system of claim 16, wherein the comprehension work unit is a run-length comprehension work unit, a join comprehension work unit, a choice comprehension work unit, or a merge comprehension work unit.

19. The system of claim 16, wherein the programming pattern is a plurality of work units arranged sequentially, and wherein each work unit in the plurality of work units has one input and one output message.

20. The system of claim 16, wherein the programming pattern comprises at least two work units that receive a common input and that produce a join output.
